(19) United States
(12) Patent Application Publication
(10) Pub. No.: US 2023/0134086 A1
(43) Pub. Date: May 4, 2023

(54) SHEET TRANSPORTATION DEVICE AND IMAGE FORMING APPARATUS

(71) Applicant: FUJIFILM Business Innovation Corp., Tokyo (JP)

(72) Inventors: Keisuke MATSUZAWA, Kanagawa (JP); Yoshinori SHUIN, Kanagawa (JP)

(73) Assignee: FUJIFILM Business Innovation Corp., Tokyo (JP)

(21) Appl. No.: 17/827,784

(22) Filed: May 29, 2022

(30) Foreign Application Priority Data
Nov. 2, 2021 (JP) 2021-179754

(51) Int. Cl. B65H 5/02; G03G 15/00

(52) U.S. Cl. CPC B65H 5/025; G03G 15/6555; G03G 2215/00679

(57) ABSTRACT

A sheet transportation device includes a first transport roller that transports a sheet member toward a first direction, a second transport roller that is arranged on a downstream side of the first transport roller in a transport direction of the sheet member and transports the sheet member in a second direction different from the first direction, and a guide portion that guides the sheet member by coming into contact with a leading end of the sheet member in a region on a second transport roller side with respect to a first line extending from a part of the first transport roller, in which the sheet member is pinched, in the first direction and on an opposite side to a first transport roller side with respect to a second line extending from a part of the second transport roller, in which the sheet member is pinched, in the second direction.

### CROSS-REFERENCE TO RELATED APPLICATIONS

This application is based on and claims priority under 35 USC 119 from Japanese Patent Application No. 2021-179754 filed Nov. 2, 2021.

### BACKGROUND

### (i) Technical Field

The present invention relates to a sheet transportation device and an image forming apparatus.

### (ii) Related Art

A sheet transportation device described in JP2020-190657A includes transport means that transports a sheet toward a predetermined position, a motor that drives the transport means, sheet detection means that detects the sheet on a sheet transport path toward the predetermined position via the transport means, torque detection means that detects load torque applied to the motor, and control means that executes speed control of changing a rotation speed of the motor according to a timing when the sheet detection means has detected the sheet during execution of a transport operation of transporting the sheet with the transport means.

### SUMMARY

The sheet transportation device that transports a sheet member includes a plurality of transport rollers arranged with an interval from an upstream side to a downstream side in a transport direction of the sheet member.

For convenience of a machine layout, the transport direction of the sheet member is different in some cases between a first transport roller and a second transport roller arranged on the downstream side of the first transport roller in the transport direction of the sheet member. Specifically, the first transport roller transports the sheet member toward a first direction, and the second transport roller transports the sheet member toward a second direction different from the first direction in some cases. In such a case, a guide portion that guides the sheet member transported by the first transport roller toward the second transport roller is provided.

The guide portion guides the sheet member in a region pinched between a first line extending from a part of the first transport roller, in which the sheet member is pinched, in the first direction and a second line extending from a part of the second transport roller, in which the sheet member is pinched, in the second direction. In such a case, the transported sheet member receives a resistance from the guide portion. The resistance increases in some cases.

Aspects of non-limiting embodiments of the present disclosure relate to a sheet transportation device and an image forming apparatus that decrease a resistance received by a transported sheet member from a guide portion compared to a case where the transported sheet member passes through only a region pinched between a first line and a second line.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided that a sheet transportation device includes a first transport roller that transports a sheet member toward a first direction, a second transport roller that is arranged on a downstream side of the first transport roller in a transport direction of the sheet member and transports the sheet member in a second direction different from the first direction, and a guide portion that guides the sheet member by coming into contact with a leading end of the sheet member in a region on a second transport roller side with respect to a first line extending from a part of the first transport roller, in which the sheet member is pinched, in the first direction and on an opposite side to a first transport roller side with respect to a second line extending from a part of the second transport roller, in which the sheet member is pinched, in the second direction.

### BRIEF DESCRIPTION OF THE DRAWINGS

Exemplary embodiment(s) of the present invention will be described in detail based on the following figures, wherein:

FIG. 1 is a schematic configuration view showing an image forming apparatus according to an exemplary embodiment of the present disclosure;

FIG. 2 is a configuration view showing an image forming unit of the image forming apparatus according to the exemplary embodiment of the present disclosure;

FIG. 3 is a configuration view showing a transporting unit according to the exemplary embodiment of the present disclosure;

FIG. 4 is an enlarged configuration view showing the transporting unit according to the exemplary embodiment of the present disclosure;

FIGS. 5A, 5B, 5C, 5D, 5E, and 5F are side views showing a sheet member transported by the transporting unit according to the exemplary embodiment of the present disclosure;

FIGS. 6A, 6B, and 6C are side views showing the sheet member transported by the transporting unit according to the exemplary embodiment of the present disclosure;

FIG. 7 is a view showing a graph comparing the transporting unit according to the exemplary embodiment of the present disclosure to a transporting unit according to a comparative embodiment of the exemplary embodiment;

FIG. 8 is a configuration view showing the transporting unit according to the comparative embodiment of the exemplary embodiment of the present disclosure; and

FIGS. 9A, 9B, 9C, 9D, 9E, and 9F are side views showing the sheet member transported by the transporting unit according to the comparative embodiment with respect to the transporting unit according to the exemplary embodiment of the present disclosure.

### DETAILED DESCRIPTION

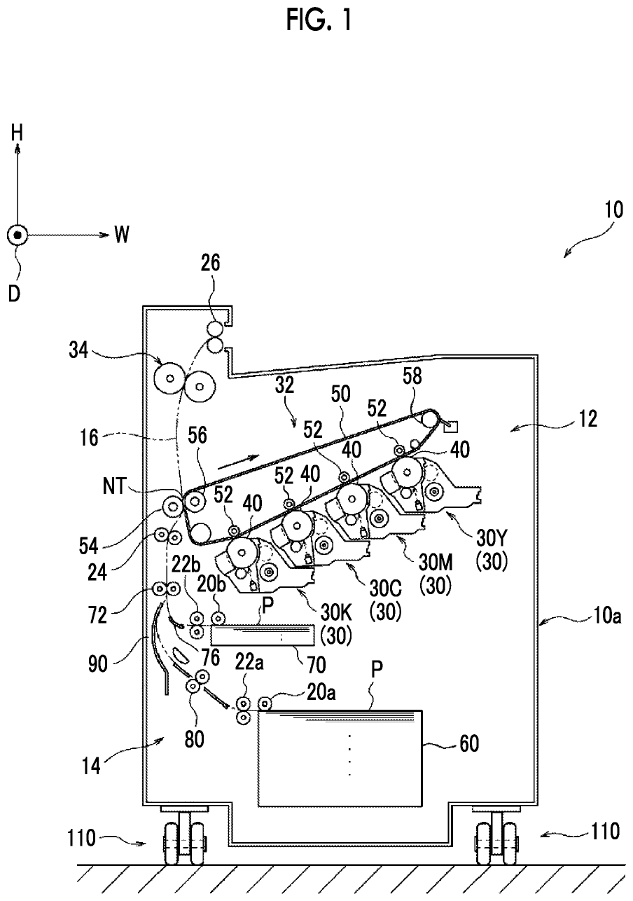

Examples of a sheet transportation device and an image forming apparatus according to an exemplary embodiment of the present disclosure will be described with reference to FIGS. 1 to 9. An arrow H shown in each drawing indicates a device up-down direction, which is a vertical direction, an arrow W indicates a device width direction, which is a horizontal direction, and an arrow D indicates a device depth direction, which is a horizontal direction.

Overall Configuration of Image Forming Apparatus

As shown in FIG. 1, an image forming apparatus 10 includes an image forming unit 12 that forms a toner image through an electrophotographic method and accommodating units 60 and 70 that accommodate a transporting unit 14 transporting a sheet member P along a transport path 16 and the sheet member P.

In the image forming apparatus 10 having the configuration, the sheet member P is accommodated by the accommodating units 60 and 70, and the sheet member P accommodated in any one of the accommodating units 60 and 70 is transported along the transport path 16 by the transporting unit 14. Further, a toner image formed by the image forming unit 12 is formed on the transported sheet member P, and the sheet member P on which the toner image is formed is discharged to the outside of an apparatus body 10a.

Image Forming Unit 12

As shown in FIG. 1, the image forming unit 12 includes a plurality of toner image forming units 30 that form respective colors of toner images and a transfer unit 32 that transfers the toner images formed by the toner image forming units 30 to the sheet member P. Further, the image forming unit 12 includes a fixing device 34 that fixes the toner images, which are transferred to the sheet member P by the transfer unit 32, to the sheet member P.

Toner Image Forming Unit 30

The plurality of toner image forming units 30 are included to form a toner image for each color. In the present exemplary embodiment, in total, four colors of yellow (Y), magenta (M), cyan (C), and black (K) toner image forming units 30 are provided. In the following description, in a case where it is not necessary to distinguish between yellow (Y), magenta (M), cyan (C), and black (K), Y, M, C, and K attached to the reference numerals are omitted.

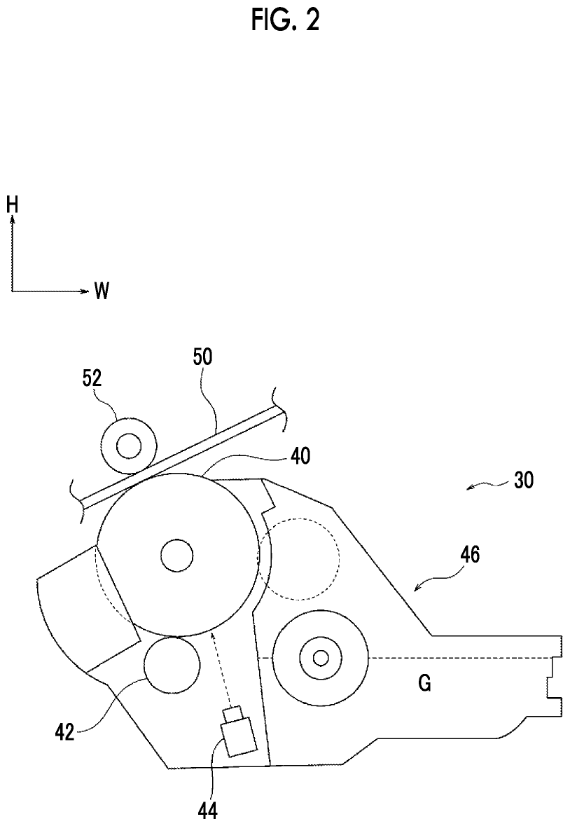

As shown in FIG. 2, the toner image forming unit 30 having each color is basically configured the same except for a toner to be used and includes a rotating circular image holding body 40 and a charger 42 that charges the image holding body 40. Further, the toner image forming unit 30 includes an exposure device 44 that irradiates the charged image holding body 40 with exposure light and forms an electrostatic latent image and a developing device 46 that develops the electrostatic latent image with a developer G containing a toner as a toner image.

Accordingly, the toner image forming unit 30 having each color forms an image having each color using each color of toner.

In addition, as shown in FIG. 1, the image holding body 40 having each color is in contact with a transfer belt 50 (details to be described later) that moves around. In a circumferential direction (see an arrow in FIG. 1) of the transfer belt 50, the yellow (Y), magenta (M), cyan (C), and black (K) toner image forming units 30 are arranged side by side in turn from an upstream side.

Transfer Unit 32

As shown in FIG. 1, the transfer unit 32 includes the transfer belt 50 and primary transfer rollers 52 each of which is arranged on an opposite side of the image holding body 40 having each color with the transfer belt 50 pinched therebetween and transfers a toner image formed on the image holding body 40 having each color to the transfer belt 50.

In addition, the transfer unit 32 includes a winding roller 56 around which the transfer belt 50 is wound and a drive roller 58 around which the transfer belt 50 is wound and which transmits a rotational force to the transfer belt 50. Accordingly, the transfer belt 50 moves around in an arrow direction in FIG. 1.

Further, the transfer unit 32 includes a secondary transfer roller 54 that is arranged on the opposite side of the winding roller 56 with the transfer belt 50 pinched therebetween and that transfers a toner image transferred to the transfer belt 50 to the sheet member P. A transfer nip NT where the toner image is transferred to the sheet member P is formed between the secondary transfer roller 54 and the transfer belt 50.

In the configuration, in order of yellow (Y), magenta (M), cyan (C), and black (K), the toner image is primarily transferred to the transfer belt 50 by the primary transfer roller 52. On the other hand, the toner image is transferred by the secondary transfer roller 54 from the transfer belt 50 to the sheet member P transported while being pinched between the transfer belt 50 and the secondary transfer roller 54. Further, the sheet member P to which the toner image is transferred is transported toward the fixing device 34.

Fixing Device 34

As shown in FIG. 1, the fixing device 34 is arranged on a downstream side of the transfer nip NT in a transport direction of the sheet member P. The fixing device 34 heats and pressurizes the toner image transferred to the sheet member P and fixes the toner image to the sheet member P.

Accommodating Units 60 and 70

As shown in FIG. 1, the accommodating units 60 and 70 are arranged at a lower portion inside the apparatus body 10a, and the sheet members P can be stacked therein. Details of the accommodating units 60 and 70 will be described later.

Transporting Unit 14

As shown in FIG. 1, the transporting unit 14 transports the sheet member P accommodated in the accommodating units 60 and 70 along the transport path 16. Details of the accommodating units 60 and 70 will be described later.

Others

As shown in FIG. 1, the image forming apparatus 10 includes a plurality of castors 110 that make the apparatus body 10a easily movable. The castors 110 are attached to four corners of a lower end of the apparatus body 10a, respectively.

Major Portion Configuration

Next, the accommodating units 60 and 70 and the transporting unit 14 will be described. The transporting unit 14 is an example of the sheet transportation device.

Accommodating Units 60 and 70

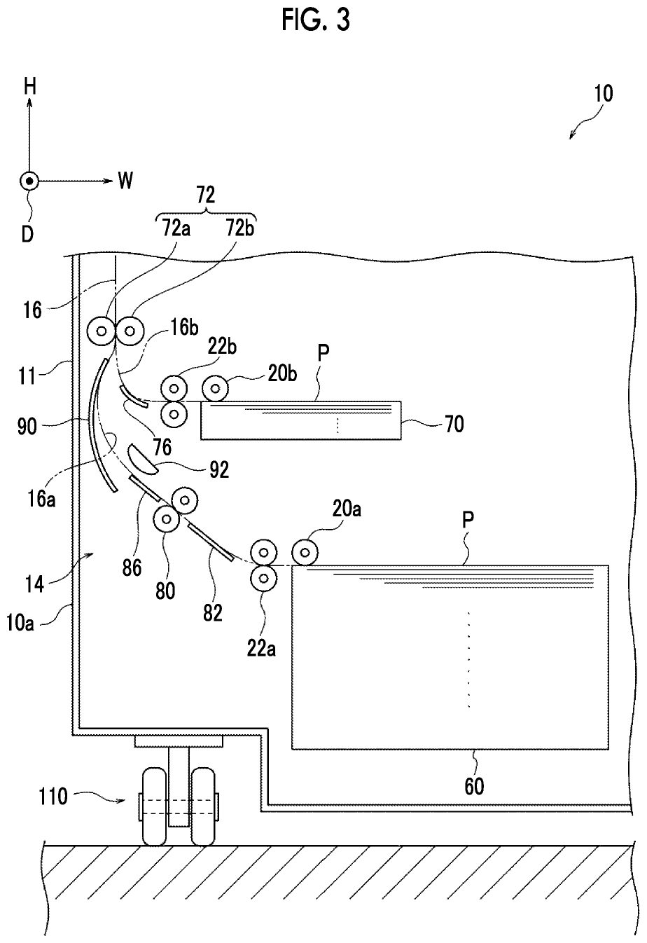

As shown in FIG. 3, the accommodating units 60 and 70 are arranged in the device up-down direction. The accommodating unit 60 is arranged below the accommodating unit 70 and on one side (the left in FIG. 3) in the device width direction. In the device up-down direction, a lower portion of the accommodating unit 60 overlaps upper portions of the castors 110.

In the present exemplary embodiment, the accommodating unit 60 generally accommodates the A4 sheet member P, and the accommodating unit 70 generally accommodates the postcard-sized sheet member P. In the image forming apparatus 10, the consumption of the A4 sheet member P is the largest. The number of sheets that can be accommodated in the accommodating unit 60 accommodating the sheet members P of which the consumption is the largest is larger than the number of sheets that can be accommodated in the accommodating unit 70. In other words, the thickness of the accommodating unit 60 in the device up-down direction is larger than the thickness of the accommodating unit 70 in the device up-down direction.

Transporting Unit 14

As shown in FIG. 1, the transporting unit 14 includes an adjusting roller 24 that is arranged on the upstream side of the transfer nip NT in the transport direction of the sheet member P (hereinafter, simply referred to as a “sheet transport direction”) and adjusts a timing when the sheet member P is fed to the transfer nip NT. The transporting unit 14 further includes a discharge roller 26 that is arranged on the downstream side in the sheet transport direction and that discharges the sheet member P to which a toner image is fixed by the fixing device 34 to the outside of the apparatus body 10a.

In addition, the transporting unit 14 includes a feeding roller 20b that feeds the sheet member P accommodated in the accommodating unit 70 to the transport path 16 and a prevention roller 22b that prevents double-feeding of the sheet members P fed by the feeding roller 20b. The prevention roller 22b is an example of a third transport roller.

The transporting unit 14 further includes a transport roller 72 that is arranged between the prevention roller 22b and the adjusting roller 24 in the sheet transport direction and a guide plate 76 that guides the sheet member P transported by the prevention roller 22b toward the transport roller 72.

In addition, as shown in FIG. 3, the transporting unit 14 includes a feeding roller 20a that feeds the sheet member P accommodated in the accommodating unit 60 to the transport path 16 and a prevention roller 22a that prevents double-feeding of the sheet members P fed by the feeding roller 20a.

In addition, the transporting unit 14 further includes a transport roller 80 that is arranged between the prevention roller 22a and the transport roller 72 in the sheet transport direction and a guide plate 82 that guides the sheet member P transported by the prevention roller 22a toward the transport roller 80.

The transporting unit 14 further includes a guide plate 86 and a guide plate 90 that guide the sheet member P transported by the transport roller 80 toward the transport roller 72 and a restricting unit 92.

The transport path 16 is divided into two paths on the upstream side of the transport roller 72 in the sheet transport direction. One is a transport path 16a through which the sheet members P stacked on the accommodating unit 60 are transported, and the other is a transport path 16b through which the sheet members P stacked on the accommodating unit 70 are transported.

Transport Roller 72

The transport roller 72 has the device depth direction as an axial direction and is arranged above the accommodating unit 70 in the device up-down direction with a gap with respect to a side wall 11 of the apparatus body 10a as shown in FIG. 3. The transport roller 72 is arranged to transport the sheet member P in the device up-down direction and includes a pair of roller portions 72a and 72b. The transport roller 72 is an example of a second transport roller, and the device up-down direction is an example of a second direction.

In addition, the roller portion 72a and the roller portion 72b are arranged in the device width direction, the roller portion 72a is arranged on a side wall 11 side, and the roller portion 72b is arranged on the opposite side of the side wall 11 with the roller portion 72a interposed therebetween. In the present exemplary embodiment, the roller portion 72b is driven, and the roller portion 72a is driven by the roller portion 72b. The roller portion 72b is an example of one roller portion, and the roller portion 72a is an example of the other roller portion.

Feeding Roller 20b, Prevention Roller 22b, and Guide Plate 76

As shown in FIG. 3, the feeding roller 20b is arranged to be in contact with the uppermost sheet member P accommodated in the accommodating unit 70, and the uppermost sheet member P is fed to the transport path 16b.

The prevention roller 22b is arranged below the transport roller 72 and on one side (the right in FIG. 3) of the transport roller 72 in the device width direction. The prevention roller 22b transports the sheet member P toward the device width direction.

The guide plate 76 is curved such that the opposite side of the transport path 16b is convex in a case of being viewed from the device depth direction. The guide plate 76 guides the sheet member P transported in the device width direction by the prevention roller 22b toward the transport roller 72 that transports the sheet member P in the device up-down direction. The guide plate 76 is an example of another guide portion.

Feeding Roller 20a, Prevention Roller 22a, and Guide Plate 82

As shown in FIG. 3, the feeding roller 20a is arranged to be in contact with the uppermost sheet member P accommodated in the accommodating unit 60, and the uppermost sheet member P is fed to the transport path 16a.

The prevention roller 22a is arranged below the transport roller 72 and on the one side (the right in FIG. 3) of the transport roller 72 in the device width direction. The prevention roller 22a transports the sheet member P toward the device width direction.

The guide plate 82 is linear in a case of being viewed from the device depth direction and is inclined with respect to the device width direction such that one side in the device width direction is lower than the other side. The guide plate 82 guides the sheet member P transported in the device width direction by the prevention roller 22a toward the transport roller 80.

Transport Roller 80, Guide Plate 86, Guide Plate 90, and Restricting Unit 92

The transport roller 80 has the device depth direction as an axial direction and is arranged between the transport roller 72 and the prevention roller 22a in the device up-down direction and the device width direction as shown in FIG. 3. The transport roller 80 transports the sheet member P in a first direction in which one side in the device width direction is inclined with respect to the device width direction so as to be lower than the other side. The transport roller 80 is an example of a first transport roller.

Herein, a frictional force generated between the surface of the transport roller 80 and the sheet member P is lower than a frictional force generated between the surfaces of the prevention rollers 22a and 22b and the sheet member P in consideration of life. In other words, a force of transporting the sheet member P by the transport roller 80 is weaker than a force of transporting the prevention rollers 22a and 22b. For this reason, for example, it is preferable that a resistance received by the sheet member P transported by the transport roller 80 is lower.

The guide plate 86 is linear in a case of being viewed from the device depth direction and is inclined with respect to the device width direction such that one side in the device width direction is lower than the other side. The guide plate 86 guides the sheet member P such that the sheet member P follows the first direction while supporting the back surface of the sheet member P transported in the first direction by the transport roller 80.

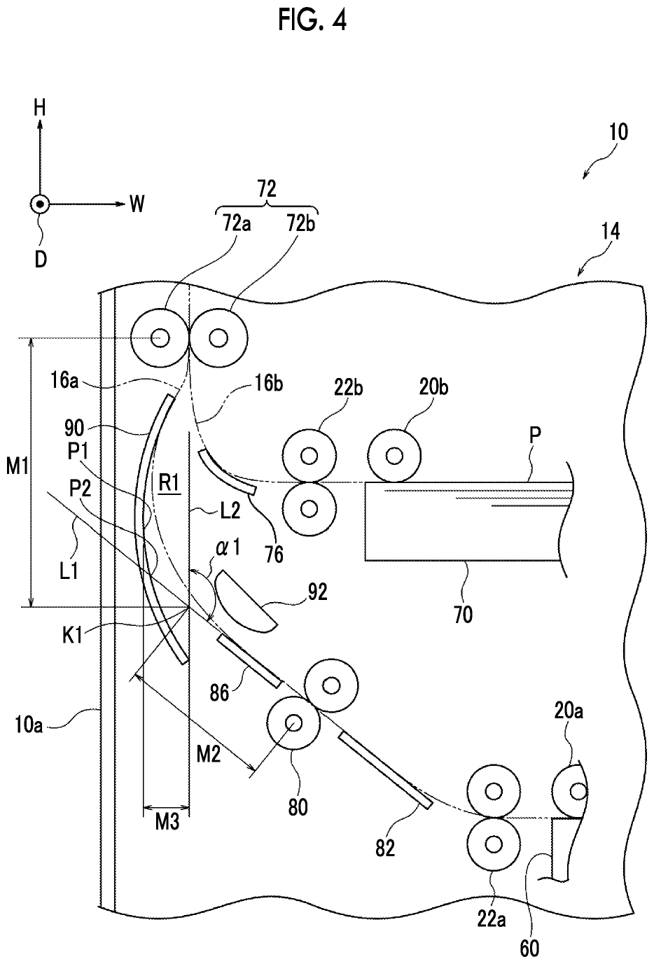

The guide plate 90 is curved such that the other side in the device width direction is convex in a case of being viewed from the device depth direction. Herein, as shown in FIG. 4, a line extending from a part of the transport roller 80, in which the sheet member P is pinched, in the first direction will be defined as a first line L1, and a line extending from a part of the transport roller 72, in which the sheet member P is pinched, in the device up-down direction (second direction) will be defined as a second line L2. Then, the guide plate 90 is curved such that a side separating away from the second line L2 in the device width direction is convex in a case of being viewed from the device depth direction. In other words, the guide plate 90 is curved such that a transported sheet member P side is recessed is concave in a case of being viewed from the device depth direction. The guide plate 90 is an example of the guide portion, and further, a point P1 in the guide plate 90, which is the farthest from the second line L2, is located on the downstream side in the sheet transport direction with respect to a point P2 where the guide plate 90 and the first line L1 intersect each other.

The guide plate 90 guides the sheet member P by coming into contact with a leading end of the sheet member P in a region (a region R1 in FIG. 4) on a transport roller 72 side with respect to the first line L1 and on the opposite side to a side where the transport roller 80 is arranged with respect to the second line L2. In the present exemplary embodiment, an angle al formed by the first line L1 and the second line L2 is 132 [degrees].

In addition, in a case of being viewed from the device depth direction, the guide plate 90 is arranged in a region where the transport roller 72 is arranged in the device width direction. In other words, in a case of being viewed from the axial direction of the transport roller 80, the guide plate 90 is arranged in the region where the transport roller 72 is arranged in a direction perpendicular to the axial direction of the transport roller 80 and is parallel to a horizontal plane. Accordingly, in the region where the transport roller 72 is arranged in the device width direction, the guide plate 90 comes into contact with at least a part of the leading end of the sheet member P and guides the sheet member P such that the leading end of the sheet member P moves on a curved trajectory. In other words, the guide plate 90 comes into contact with at least a part of the leading end of the sheet member P and guides the sheet member P such that the leading end of the sheet member P moves on a smooth curved trajectory.

Specifically, as a moving direction of the leading end of the transported sheet member P changes from a direction inclined on one side with respect to the device up-down direction to a direction inclined on the other side with respect to the device up-down direction, the leading end of the sheet member P moves on a curved trajectory.

The restricting unit 92 is arranged on the opposite side to the guide plate 86 with the transport path 16a placed therebetween. Accordingly, the restricting unit 92 comes into contact with the front surface of the sheet member P that is transported while the leading end thereof is in contact with the guide plate 90 and restricts a transport position of the sheet member P.

Action

Next, action of the transporting unit 14 will be described. In particular, a process of transporting the sheet members P stacked in the accommodating unit 70 to the transport roller 72 and a process of transporting the sheet members P stacked in the accommodating unit 60 to the transport roller 72 will be described. The process of transporting the sheet members P stacked in the accommodating unit 60 to the transport roller 72 will be described in comparison to a transporting unit 214 according to a comparative embodiment.

Transport of Sheet Members P Stacked in Accommodating Unit 70

In the transporting unit 14, the feeding roller 20b shown in FIG. 3 feeds the uppermost sheet member P stacked in the accommodating unit 70 from the accommodating unit 70 toward the prevention roller 22b. The prevention roller 22b receives the sheet member P from the feeding roller 20b and transports the sheet member.

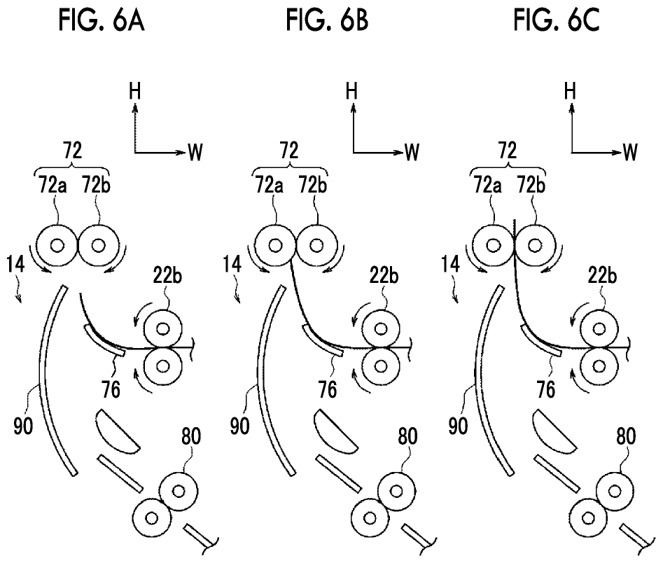

As shown in FIG. 6A, the sheet member P transported by the prevention roller 22b is guided along a plate surface of the curved guide plate 76. Further, as shown in FIGS. 6B and 6C, the leading end of the sheet member P comes into contact with a roller surface of the roller portion 72a and is moved by the rotating roller portion 72a. The sheet member P is transported while being pinched in the transport roller 72.

Configuration of Transporting Unit 214

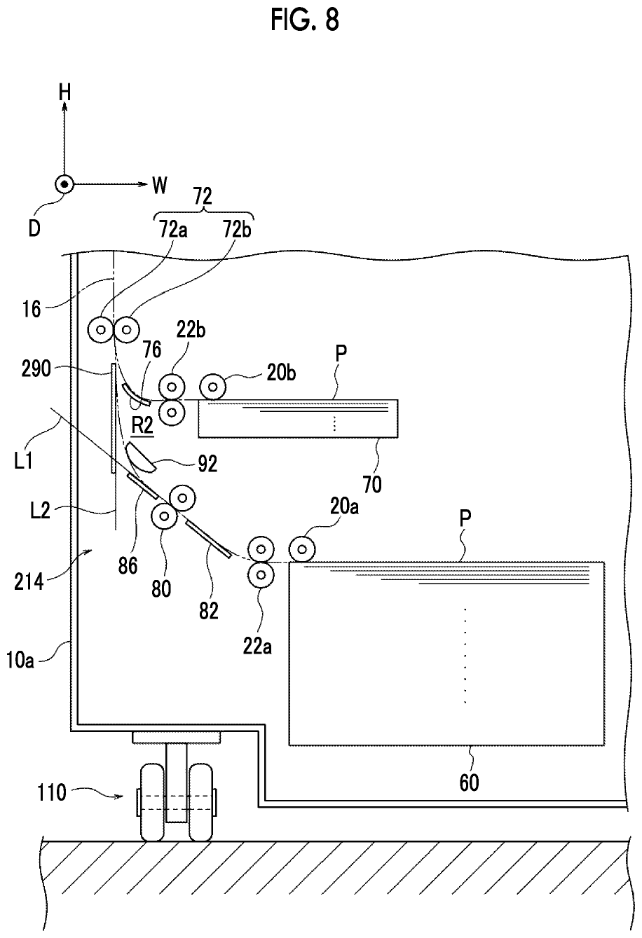

As shown in FIG. 8, the transporting unit 214 according to the comparative embodiment includes the transport roller 72, the feeding roller 20b, the prevention roller 22b, and the guide plate 76. Further, the transporting unit 214 includes the feeding roller 20a, the prevention roller 22a, the guide plate 82, the transport roller 80, the guide plate 86, a guide plate 290, and the restricting unit 92. That is, the transporting unit 214 does not include the guide plate 90 compared to the transporting unit 14 and includes the guide plate 290.

The guide plate 290 has a flat plate surface overlapping the second line L2 in a case of being viewed from the device depth direction and guides the sheet member P having the leading end in contact with the guide plate 290 toward the transport roller 72. That is, the transporting unit 214 guides the sheet member P such that the sheet member P passes through a region (a region R2 in FIG. 8) pinched between the first line L1 and the second line L2. The region R2 includes the first line L1 and the second line L2.

Transport of Sheet Members P Stacked in Accommodating Unit 60

In the transporting units 14 and 214, the feeding roller 20a shown in FIGS. 3 and 8 feeds the uppermost sheet member P stacked in the accommodating unit 60 from the accommodating unit 60 toward the prevention roller 22a. The prevention roller 22a receives the sheet member P from the feeding roller 20a and transports the sheet member.

The prevention roller 22a transports the sheet member P in the device width direction. Further, the guide plate 82 inclined with respect to the device width direction supports the back surface of the sheet member P transported by the prevention roller 22a and guides the sheet member toward the transport roller 80. In addition, the transport roller 80 receives the sheet member P guided by the guide plate 82 and transports the sheet member.

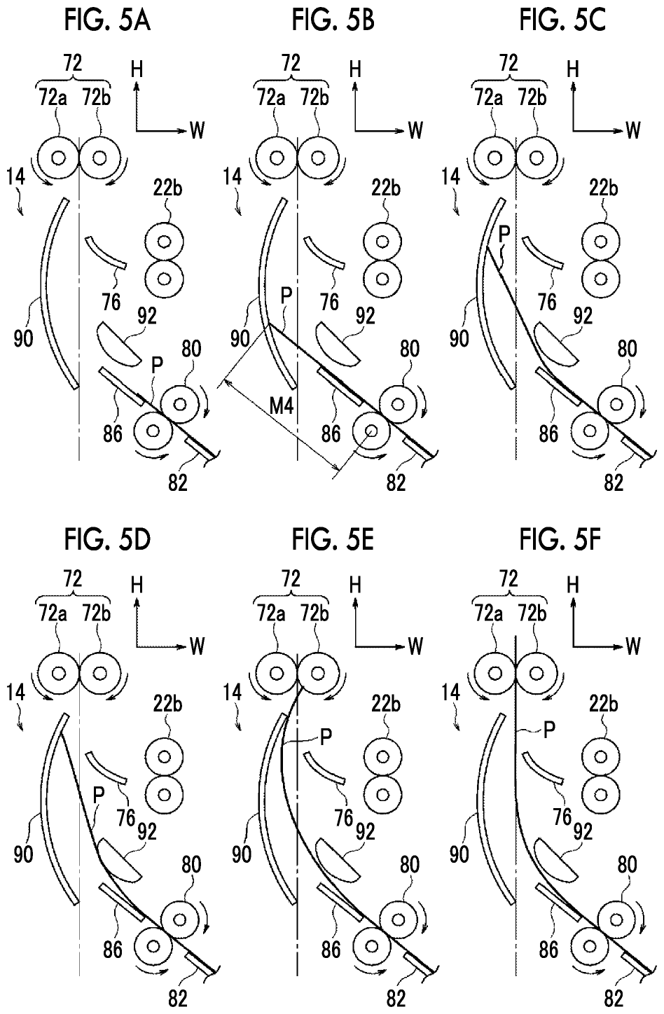

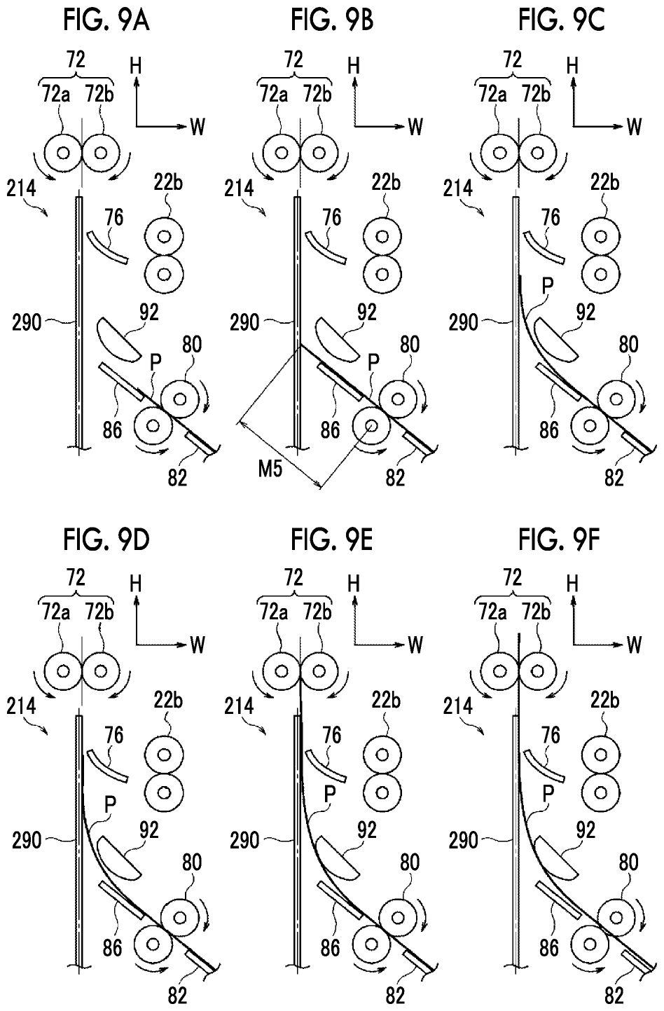

As shown in FIGS. 5A and 9A, the sheet member P transported by the transport roller 80 has the back surface supported by the guide plate 86 and is transported while being inclined with respect to the device width direction.

Herein, as shown in FIG. 9B, in the transporting unit 214 according to the comparative embodiment, the leading end of the sheet member P transported while being inclined with respect to the device width direction comes into contact with the flat plate surface of the guide plate 290. Further, as shown in FIG. 9C, as the leading end of the sheet member P moves on a linear trajectory along the plate surface of the guide plate 290, the sheet member P is guided by the guide plate 290 toward the transport roller 72.

Further, as shown in FIG. 9D, a sheet surface of a leading end portion of the sheet member P comes into contact with the plate surface of the guide plate 290, and the sheet member P is guided by the guide plate 290 toward the transport roller 72. The leading end of the sheet member P comes into contact with a pinched portion between the roller portion 72a and the roller portion 72b, and the sheet member P is transported by the transport roller 72 as shown in FIGS. 9E and 9F.

On the contrary, as shown in FIG. 5B, in the transporting unit 14 according to the exemplary embodiment, the leading end of the sheet member P transported while being inclined with respect to the device width direction comes into contact with the curved plate surface of the guide plate 90. In addition, as shown in FIG. 5C, as the leading end of the sheet member P moves on a curved trajectory along the plate surface of the guide plate 90, the sheet member P is guided by the guide plate 90 toward the transport roller 72. In other words, as the leading end of the sheet member P moves on a smooth curved trajectory along the plate surface of the guide plate 90, the sheet member P is guided by the guide plate 90 toward the transport roller 72.

Further, as shown in FIG. 5D, as the leading end of the sheet member P moves on a curved trajectory along the plate surface of the guide plate 90, the sheet member P is guided by the guide plate 90 toward the transport roller 72. In addition, as shown in FIGS. 5E and 5F, the leading end of the sheet member P comes into contact with a roller surface of the roller portion 72b and is moved by the rotating roller portion 72b. The sheet member P is transported while being pinched in the transport roller 72.

As shown in FIG. 5E, after the leading end of the sheet member P is separated away from the guide plate 90, the guide plate 90 comes into contact with the sheet surface of the sheet member P and guides the sheet member P.

Analysis

Next, as for the transporting unit 14 and the transporting unit 214, results obtained by analyzing a resistance received by the sheet member P, which is transported from the accommodating unit 60, from the guide plates 90 and 290 using the finite element method will be described.

Analysis Specifications
In the transporting unit 14 and the transporting unit 214, the angle al formed by the first line L1 and the second line L2 is 132 [degrees] (see FIG. 4).
In the transporting unit 14 and the transporting unit 214, a distance M1 from an intersection Kl between the first line L1 and the second line L2 to an axis of the transport roller 72 in the second direction (vertical direction) is 73 [mm] (see FIG. 4).
In the transporting unit 14 and the transporting unit 214, a distance M2 from the intersection Kl between the first line L1 and the second line L2 to an axis of the transport roller 80 in the first direction is 42 [mm] (see FIG. 4).
A maximum distance M3 between the curved plate surface of the guide plate 90 in the transporting unit 14 and the second line L2 in the device width direction is 12 [mm] (see FIG. 4).
The bending R of the curved plate surface of the guide plate 90 in the transporting unit 14 is 62 [mm] (see FIG. 4).
The plate surface of the guide plate 290 in the transporting unit 214 follows the device up-down direction (see FIG. 8).

Specifications other than the specifications described above are the same specifications used for the transporting unit 14 and the transporting unit 214.

Analysis Conditions

Analysis conditions such as the transport force of the transport roller 80 are the same conditions for the transporting unit 14 and the transporting unit 214.

Analysis Results

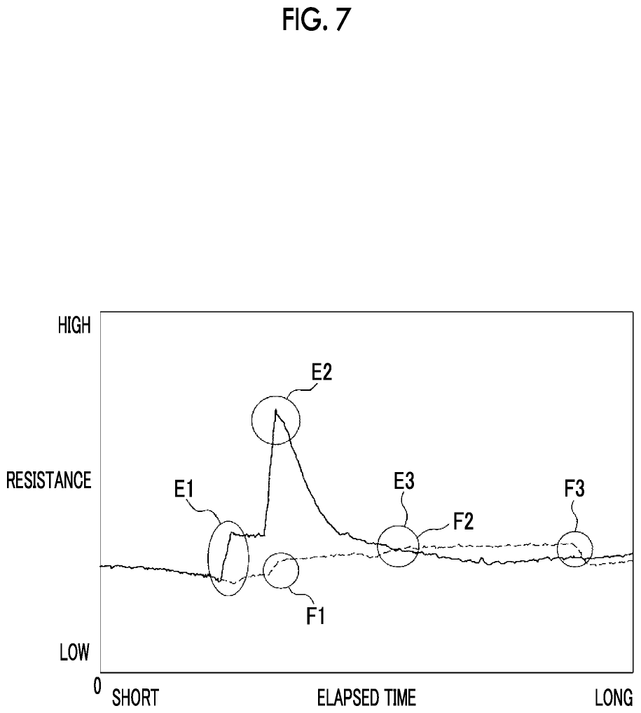

Analysis results will be described using a graph in FIG. 7. The vertical axis of the graph shown in FIG. 7 represents a resistance received by the transported sheet member P from the guide plate, and the horizontal axis of the graph represents elapsed time. A broken line in the graph indicates analysis results of the transporting unit 14, and a solid line in the graph indicates analysis results of the transporting unit 214.

In a case where the leading end of the sheet member P comes into contact with the guide plate 290 and the moving direction of the leading end abruptly changes in the transporting unit 214 as shown in FIG. 9B, a resistance received by the sheet member P increases as indicated by a part E1 in the graph.

Further, in a case where the leading end portion of the sheet member P comes into contact with the plate surface of the guide plate 290 and bends in the transporting unit 214 as shown in FIG. 9C, a resistance received by the sheet member P further increases and reaches a peak value as indicated by a part E2 in the graph.

In addition, in a case where the sheet surface of the leading end portion of the sheet member P comes into contact with the plate surface of the guide plate 290 in the transporting unit 214 as shown in FIG. 9D, a resistance received by the sheet member P decreases as indicated by a part E3 in the graph.

On the contrary, in a case where the leading end of the sheet member P comes into contact with the guide plate 90 and the moving direction of the leading end changes in the transporting unit 14 as shown in FIG. 5B, a resistance received by the sheet member P increases as indicated by a part F1 in the graph.

However, a distance M4 between a position where the leading end of the sheet member P comes into contact with the guide plate 90 and the axis of the transport roller 80 in the first direction is longer than a distance M5 between a position where the leading end of the sheet member P comes into contact with the guide plate 290 and the axis of the transport roller 80 in the first direction (see FIG. 9B).

Further, in the transporting unit 14, the leading end of the sheet member P that is in contact with the guide plate 90 moves in a direction separating away from the second line L2 (see FIG. 4) extending in the device up-down direction. For this reason, the transporting unit 14 has a degree of a resistance increase smaller than the degree of the transporting unit 214.

Further, in a case where the leading end of the sheet member P moves on a curved trajectory while being in contact with the curved surface of the guide plate 90 in the transporting unit 14 and the sheet member P warps as shown in FIG. 5C, a resistance gradually increases as indicated by a part F2 in the graph.

In addition, in a case where the leading end of the sheet member P moves on a curved trajectory while being in contact with the curved surface of the guide plate 90 in the transporting unit 14 and the sheet member P warps as shown in FIGS. 5D and 5E, a resistance that has gradually increased reaches the peak as indicated by a part F3 in the graph.

However, as can be seen by comparing FIGS. 5A to 5F to FIGS. 9A to 9F, the transporting unit 14 generally has a longer distance from a position where the sheet member P is pinched in the transport roller 80 to a position where the sheet member P comes into contact with the guide plates 90 and 290 than the distance of the transporting unit 214. For this reason, as in the graph shown in FIG. 7, a peak resistance in the transporting unit 14 is lower than a peak in the transporting unit 214.

Outline

As described above, a resistance received by the transported sheet member P from the guide plate 90 is lower in the transporting unit 14 than in the transporting unit 214 in which the sheet member P passes through only the region R2 pinched between the first line L1 and the second line L2.

In addition, in the transporting unit 14, the guide plate 90 guides the sheet member P such that the leading end of the sheet member P moves on a curved trajectory having the convex side separating away from the second line L2 in the device width direction in a case of being viewed from the device depth direction. For this reason, compared to a case where the moving direction of the leading end of the sheet member P abruptly changes, an abrupt change in a resistance received by the sheet member P from the guide plate 90 is suppressed.

In addition, the guide plate 90 moves such that the leading end of the sheet member P moves on a curved trajectory in the region where the transport roller 72 is arranged in the device width direction in the transporting unit 14. Accordingly, compared to a case where the leading end of the sheet member P moves outside a region where the transport roller 72 is provided in the device width direction, a range where the guide plate 90 and the transport roller 72 are provided in the device width direction is narrow.

In addition, in the transporting unit 14, the guide plate 90 is curved such that the side separating away from the second line L2 in the device width direction is convex in a case of being viewed from the device depth direction. Accordingly, compared to a case where a bent portion is formed in the guide plate, an abrupt change in a resistance received by the sheet member P from the guide plate 90 is suppressed.

In addition, in the transporting unit 14, the guide plate 90 is arranged in the region where the transport roller 72 is arranged in the device width direction. Compared to a case where the guide plate is arranged outside the region where the transport roller 72 is provided in the device width direction, the range where the guide plate 90 and the transport roller 72 are provided in the device width direction is narrow.

In addition, in the transporting unit 14, the leading end of the sheet member P guided by the guide plate 76 comes into contact with the roller portion 72a (a solid line of FIG. 6B). For this reason, compared to a case where the leading end of the sheet member P directly comes into contact with the pinched portion between the roller portion 72a and the roller portion 72b (a two-dot chain line of FIG. 6B), a resistance received by the transported sheet member P from the guide plate 76 decreases as the bending R of the sheet member P increases.

In addition, compared to a case where the image forming apparatus 10 includes the transporting unit 214, as a resistance received by the sheet member P from the guide plate 90 decreases, jamming of the sheet member P inside the apparatus body 10a is suppressed.

In addition, in the image forming apparatus 10, the lower portion of the accommodating unit 60 overlaps the upper portions of the castors 110 in the device up-down direction. For this reason, compared to a case where the accommodating unit is arranged above the castors 110, the height of the image forming apparatus 10 is lowered.

Although details of a certain exemplary embodiment of the present disclosure have been described, the present disclosure is not limited to such an exemplary embodiment, and it is clear for those skilled in the art that the present disclosure can take other various exemplary embodiments within the scope of the present disclosure. For example, although the transporting unit 14 is used in the image forming apparatus 10 adopting the electrophotographic method in the exemplary embodiment, for example, the transporting unit may be used in an image forming apparatus adopting an inkjet method.

In addition, the guide plate 90 moves such that the leading end of the sheet member P moves on a curved trajectory in the exemplary embodiment, but the leading end of the sheet member P may move in the region R1. For example, the leading end of the sheet member P may move linearly in the region R1. However, in this case, action achieved by moving the leading end on the curved trajectory is not achieved.

In addition, the guide plate 90 moves such that the leading end of the sheet member P moves on a curved trajectory in the region R2 in the exemplary embodiment, but the leading end of the sheet member P may move outside the region R2. However, in this case, action achieved by moving the leading end of the sheet member P in the region R2 is not achieved.

In addition, in the exemplary embodiment, the guide plate 90 that guides the leading end of the sheet member P is a plate-shaped member, but without being limited to the plate-shaped member, may be formed to have a curved surface with which the leading end of the sheet member P comes into contact. For example, a molded member in which the curved surface is formed may be used, curved rods may be arranged in the device depth direction, or a resin film may be bent in a curved shape.

In addition, the guide plate 76 that guides the leading end of the sheet member P is a plate-shaped member in the exemplary embodiment, but without being limited to the plate-shaped member, the sheet member P may be transported such that the leading end of the sheet member P comes into contact with the roller portion 72b. For example, the molded member in which the curved surface is formed may be used, the curved rods may be arranged in the device depth direction, or the resin film may be bent in a curved shape.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A sheet transportation device comprising:
a first transport roller that transports a sheet member toward a first direction;
a second transport roller that is arranged on a downstream side of the first transport roller in a transport direction of the sheet member and transports the sheet member in a second direction different from the first direction; and
a guide portion that guides the sheet member by coming into contact with a leading end of the sheet member in a region on a second transport roller side with respect to a first line extending from a part of the first transport roller, in which the sheet member is pinched, in the first direction and on an opposite side to a first transport roller side with respect to a second line extending from a part of the second transport roller, in which the sheet member is pinched, in the second direction.

2. The sheet transportation device according to claim 1,
wherein the guide portion guides the sheet member such that the leading end of the sheet member moves on a curved trajectory having a convex side separating away from the second line in a horizontal direction in a case of being viewed from an axial direction of the first transport roller.

3. The sheet transportation device according to claim 2,
wherein the second direction is a device up-down direction, and
the guide portion guides the sheet member such that the leading end of the sheet member moves on the curved trajectory in a region where the second transport roller is arranged in a device width direction in a case of being viewed from the axial direction.

4. The sheet transportation device according to claim 1,
wherein a portion of the guide portion, with which the leading end of the sheet member comes into contact, is curved such that a side separating away from the second line in a horizontal direction is convex in a case of being viewed from an axial direction of the first transport roller.

5. The sheet transportation device according to claim 4,
wherein the second direction is a device up-down direction, and
the guide portion is arranged in a region where the second transport roller is arranged in a direction that is perpendicular to the axial direction and is parallel to a horizontal plane in a case of being viewed from the axial direction.

6. The sheet transportation device according to claim 3,
wherein the second transport roller has one roller portion arranged on the first transport roller side and the other roller portion that pinches the sheet member between the one roller portion and the one roller portion, and
the sheet transportation device further comprises:
a third transport roller that is arranged above the first transport roller and below the second transport roller in the device up-down direction, is arranged on the first transport roller side with respect to the second transport roller in the device width direction, and transports the sheet member toward the device width direction; and
another guide portion that guides the sheet member such that the leading end of the sheet member transported by the third transport roller comes into contact with a roller surface of the other roller portion.

7. The sheet transportation device according to claim 5,
wherein the second transport roller has one roller portion arranged on the first transport roller side and the other roller portion that pinches the sheet member between the one roller portion and the one roller portion, and
the sheet transportation device further comprises:
a third transport roller that is arranged above the first transport roller and below the second transport roller in the device up-down direction, is arranged on the first transport roller side with respect to the second transport roller in the device width direction, and transports the sheet member toward the device width direction; and
another guide portion that guides the sheet member such that the leading end of the sheet member transported by the third transport roller comes into contact with a roller surface of the other roller portion.

8. An image forming apparatus comprising:
the sheet transportation device according to claim 1; and
an image forming unit that forms an image on a sheet member transported by the sheet transportation device.

9. An image forming apparatus comprising:
the sheet transportation device according to claim 2; and
an image forming unit that forms an image on a sheet member transported by the sheet transportation device.

10. An image forming apparatus comprising:
the sheet transportation device according to claim 3; and
an image forming unit that forms an image on a sheet member transported by the sheet transportation device.

11. An image forming apparatus comprising:
the sheet transportation device according to claim 4; and
an image forming unit that forms an image on a sheet member transported by the sheet transportation device.

12. An image forming apparatus comprising:
the sheet transportation device according to claim 5; and
an image forming unit that forms an image on a sheet member transported by the sheet transportation device.

13. An image forming apparatus comprising:
the sheet transportation device according to claim 6; and
an image forming unit that forms an image on a sheet member transported by the sheet transportation device.

14. An image forming apparatus comprising:
the sheet transportation device according to claim 7; and
an image forming unit that forms an image on a sheet member transported by the sheet transportation device.
